(19) United States
(12) Patent Application Publication
(10) Pub. No.: US 2015/0165465 A1
(43) Pub. Date: Jun. 18, 2015

(54) ULTRASONIC NEBULIZER WITH CONTROLLED MIST OUTPUT

(71) Applicant: AGILENT TECHNOLOGIES, INC., Loveland, CO (US)

(72) Inventors: Michael Ron Hammer, Sassafras (AU); Alan John Roper, Melbourne (AU)

(21) Appl. No.: 14/525,097

(22) Filed: Oct. 27, 2014

Related U.S. Application Data
(60) Provisional application No. 61/917,434, filed on Dec. 18, 2013.

(51) Int. Cl. B05B 17/06

(52) U.S. Cl. CPC B05B 17/0615; B05B 17/0653

(57) ABSTRACT

An ultrasonic nebulizer includes a piezoelectric element that vibrates responsive to a drive signal having an alternating voltage. A nebulizing layer that may be a passive resonator is bonded to a first surface of the piezoelectric element and has an outer surface that transforms a liquid into a mist responsive to vibration of the piezoelectric element. A heat sink pad is in thermal contact with a heat sink and the passive resonator to dissipate heat from the piezoelectric element. The surface of the passive resonator may be roughened to guide flow of liquid.

### CROSS-REFERENCE TO RELATED APPLICATIONS

The present application claims priority under 35 U.S.C. §119(e) from commonly owned U.S. Provisional Application No. 61/917,434 filed on Dec. 18, 2013 to Hammer, et al. The entire disclosure of U.S. Provisional Application No. 61/917,434 is specifically incorporated herein by reference.

### BACKGROUND

Ultrasonic nebulizers in analytical instrumentation are capable of producing smaller diameter droplets and nebulizing a greater volume of liquid per unit volume of sample flow gas than pneumatic nebulizers. Ultrasonic nebulizers typically use a vibrating piezoelectric element oriented either vertically or at an inclined angle. The sample liquid deposited on the piezoelectric element flows over the nebulizing surface, and eventually runs off the bottom of the nebulizing surface. With a liquid film formed over the nebulizing surface, the piezoelectric element is driven to vibrate causing the formation of waves on the nebulizing surface. If the amplitude of these waves is large enough, liquid droplets break away from the crests of the waves. The size of the droplets depends on the frequency of the waves. For frequencies of around 1-2 MHz, droplet size may typically be about 2 microns, which is smaller than droplet size readily produced by pneumatic nebulization.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a top perspective view illustrating a piezoelectric element, according to a representative embodiment.

FIG. 2 is a top perspective view illustrating a resonator plate, according to a representative embodiment.

FIG. 3 is a top perspective view illustrating a piezoelectric element and a resonator plate bonded together, according to a representative embodiment.

FIG. 4 is a side perspective view further illustrating the piezoelectric element and the resonator plate of FIG. 3 bonded together, according to a representative embodiment.

FIG. 5 is a top perspective view illustrating a heat sink pad, according to a representative embodiment.

FIG. 6 is a top perspective view illustrating a heat sink, according to a representative embodiment.

FIG. 7 is a top perspective view illustrating the heat sink pad inserted into the heat sink of FIG. 6, according to a representative embodiment.

FIG. 8 is a top perspective view illustrating the transducer assembly inserted into the heat sink of FIG. 7, according to a representative embodiment.

FIG. 9 is a top perspective view illustrating an O-ring inserted into the heat sink of FIG. 8, according to a representative embodiment.

FIG. 10 is a front perspective view illustrating spray chamber body, according to a representative embodiment.

FIG. 11 is a left side perspective view illustrating an assembled nebulizer head including the heat sink and spray chamber body, according to a representative embodiment.

FIG. 12 is a schematic block diagram illustrating a controller, and a driver providing a drive signal to an assembled nebulizer head, according to a representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods may be omitted so as not to obscure the description of the example embodiments. Such methods and devices are within the scope of the present teachings.

Generally, it is understood that as used in the specification and appended claims, the terms “a”, “an” and “the” include both singular and plural referents, unless the context clearly dictates otherwise. Thus, for example, “a device” includes one device and plural devices.

As used in the specification and appended claims, and in addition to their ordinary meanings, the terms “substantial” or “substantially” mean to within acceptable limits or degree. For example, “substantially cancelled” means that one skilled in the art would consider the cancellation to be acceptable. As a further example, “substantially removed” means that one skilled in the art would consider the removal to be acceptable.

As used in the specification and the appended claims and in addition to its ordinary meaning, the term “approximately” means to within an acceptable limit or amount to one having ordinary skill in the art. For example, “approximately the same” means that one of ordinary skill in the art would consider the items being compared to be the same.

Various representative embodiments provide an ultrasonic nebulizer with controlled mist output that efficiently dissipates generated heat away from the piezoelectric element.

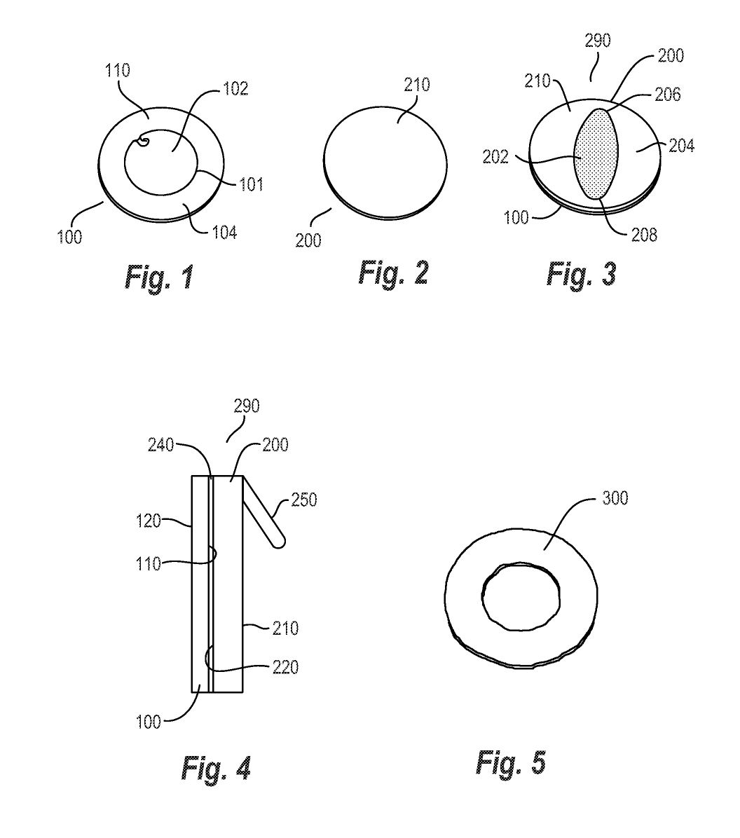

FIG. 1 is a top perspective view illustrating piezoelectric element 100, according to a representative embodiment. Piezoelectric element 100 is formed as a disk and may be a material such as lead zirconate titanate (PZT). The frequency of operation is inversely proportional to the thickness of piezoelectric element 100, and ideal frequencies may be around 0.8 MHz to 5 MHz corresponding to disk thicknesses of between about 2 mm to 0.4 mm. Piezoelectric element 100 has a first face 110 shown in FIG. 1, and an opposite second face 120 shown in FIG. 4. First face 110 as shown in FIG. 1 includes a thin contact metallization 101 such as silver deposited thereon in central region 102. Central region 102 of piezoelectric element 100 is surrounded by annular region 104 that is bare without contact metallization. In a representative embodiment, the diameter of central region 102 may be about 14 mm, and an overall diameter of piezoelectric element 100 including annular region 104 may be about 25 mm, although piezoelectric element 100 may have larger or smaller diameter. The entire second face 120 of piezoelectric element 100 is covered with a contact metallization layer such as silver (not shown). When a drive signal is applied to the contact metallization layers on the first and second faces 110 and 120, power is only dissipated under central region 102, which is the region where vibration is generated. In other representative embodiments, piezoelectric element 100 may have different thickness, and the diameter of central region 102 and the radial width of annular region 104 may be different.

FIG. 2 is a top perspective view illustrating resonator plate 200, according to a representative embodiment. In particular, resonator plate 200 is a passive resonator having an outer surface 210 and an opposite second surface 220, and is bonded to piezoelectric element 100 as shown in FIG. 4. Resonator plate 200 may be a thermally conductive material having a thermally conductivity of at least 10 watts/meter Kelvin, so that it can draw heat away from central region 102 of piezoelectric element 100. Resonator plate 200 may be made of a material such as titanium, tantalum, aluminum oxide or aluminum nitride, so as to be inert and highly resistant to corrosion by the liquid sample. Resonator plate 200 may have a thickness corresponding to an integral number of half wavelengths of the drive frequency applied to piezoelectric element 100, and may have a high mechanical quality factor at the resonant frequency. In a representative embodiment, resonator plate 200 may be a one-half wave resonator plate having a thickness one half wavelength of the drive frequency applied to piezoelectric element 100. The thickness of resonator plate 200 depends on the speed of sound in the material of the plate. For example, for a drive frequency of 1.7 MHz, a one-half wave titanium resonator plate would have a thickness of about 1.6 mm.

FIG. 3 is a top perspective view illustrating piezoelectric element 100 and resonator plate 200 bonded to each other to form transducer assembly 290. FIG. 4 is a side perspective view further illustrating piezoelectric element 100 and resonator plate 200 bonded together as transducer assembly 290. Second surface 220 of resonator plate 200 is bonded to first face 110 of piezoelectric element 100 by an adhesive 240 which may be an epoxy adhesive. Adhesive 240 should be as thin as possible, such as less than 40 microns. As described above, resonator plate 200 has a thickness corresponding to an integral number of half wavelengths of the drive frequency applied to piezoelectric element 100, and vibrates in harmony with piezoelectric element 100, whereby outer surface 210 functions as a nebulizing layer or surface that transforms a liquid into a mist responsive to vibration of piezoelectric element 100. Also, because resonator plate 200 is a thermally conductive material such as titanium, tantalum, aluminum oxide or aluminum nitride, resonator plate 200 disperses heat generated by piezoelectric element 100 radially outward away from central region 102.

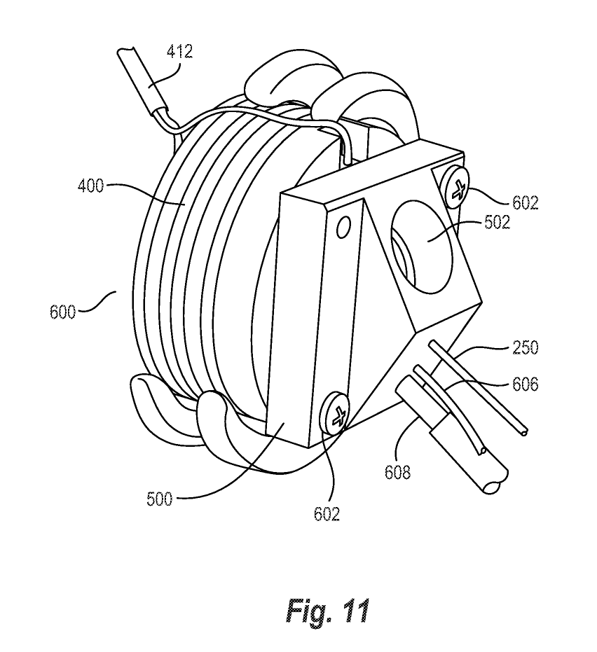

As will be described further with respect to FIG. 11, transducer assembly 290 as shown in FIG. 4 may be oriented substantially vertically or at an inclined angle. The liquid to be nebulized may be deposited near the top of resonator plate 200, to flow over outer surface 210 and off near the bottom of resonator plate 200. As shown in FIG. 3, in a representative embodiment portions of the outer surface 210 of resonator plate 200 of transducer assembly 290 may be roughened to have enhanced wettability to thereby guide flow of liquid over outer surface (nebulizing layer) 210. First portion 202 of outer surface 210 may be roughened using an appropriate mask by sand blasting, chemical etching plasma or any appropriate surface texturing technique. Second portion 204 of outer surface 210 may be made smooth by polishing for example, so as to have poor wettability and to thus help confine flow of liquid to substantially within first portion 202 of outer surface 210.

In a representative embodiment, transducer assembly 290 may be oriented substantially vertically as shown in FIG. 4. First portion 202 of outer surface 210 may thus extend in a vertical direction downward and may begin at 206 over a point located near a top edge of piezoelectric element 100, and may have a width that gradually increases to a maximum width of about 12 mm for example over central region 102 of piezoelectric element 100. The width of first portion 202 may then gradually decrease from the maximum width over central region 102 of piezoelectric element 100 to end at 208 over a point located near a bottom edge of piezoelectric element 100. In a further representative embodiment, first portion 202 may be substantially stripe-shaped having a width of about 12 mm, and may extend in the vertical direction starting over a point at or near the top edge of piezoelectric element 100 and ending over a point at or near the bottom edge of piezoelectric element 100. The maximum width of first portion 202 over central region 102, and the width of the stripe-shaped first portion 202 of the above representative embodiments may be different depending on the size of transducer assembly 290. The liquid to be nebulized may thus be deposited at or near 206, and may then flow down outer surface 210 under gravity, spreading out so as to be over and cover central region 102 of piezoelectric element 100.

As further shown in FIG. 4, a representative embodiment may include tube 250 configured to direct or deposit the liquid onto first portion 202 of outer surface 210 of resonator plate 200 at a point over annular region 104 of piezoelectric element 100 near a top edge of piezoelectric element 100. As shown in FIG. 4, tube 250 may directly contact outer surface 210 of resonator plate 200. In other representative embodiments tube 250 may be positioned so that it does not directly contact outer surface 210 of resonator plate 200, relying on surface tension of the liquid to bridge the gap. Tube 250 may be a small tube made of a suitably inert material such as polytetrafluorethylene (PTFE) or polyether ether ketone (PEEK), or even a suitable inert material or ceramic.

FIG. 5 is a top perspective view illustrating heat sink pad 300, according to a representative embodiment. Heat sink pad 300 is a ring-shaped or annular-shaped disk with an open center portion, and has an overall diameter that is substantially the same as the diameter of piezoelectric element 100. The diameter of the open center portion and the radial width of the annular portion of heat sink pad 300 are respectively substantially the same as the diameter of central region 102 and the radial width of annular region 104 of piezoelectric element 100. When stacked together, substantially the entirety of central region 102 of piezoelectric element 100 will be exposed by the open center portion of heat sink pad 300. Heat sink pad 300 may be made of a thermally conductive material such as silpad, which is a ceramic loaded fiber reinforced silicone material, and may have a thickness of about 0.3 mm.

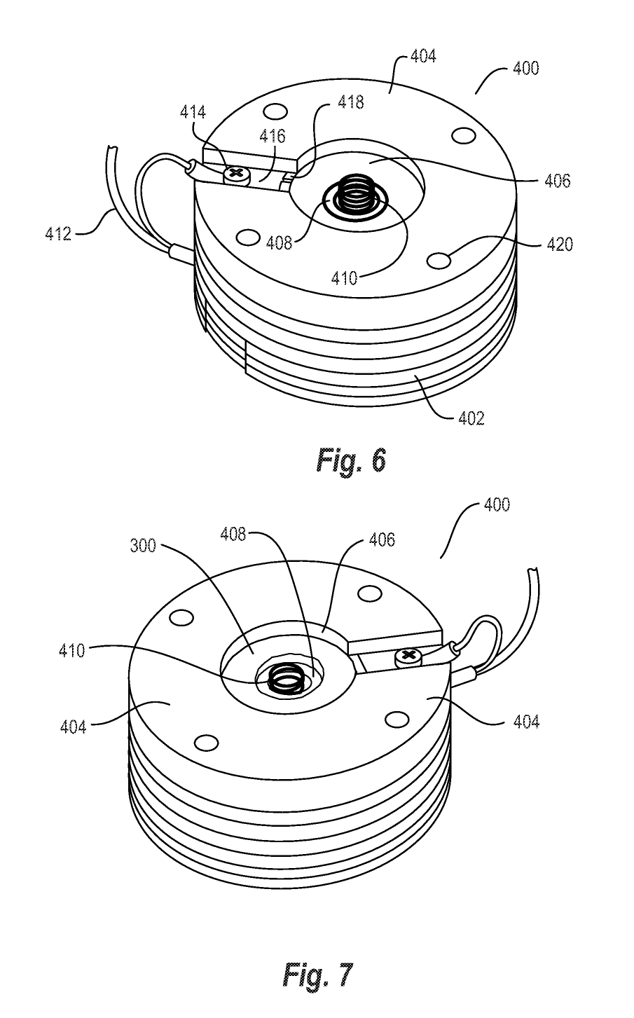

FIG. 6 is a top perspective view illustrating heat sink 400, according to a representative embodiment. In a representative embodiment, heat sink 400 may be constructed of a thermally conductive material such as aluminum. A plurality of fins 402 may be arranged along the exterior side walls of heat sink 400 to dissipate heat. A circular recessed portion 406 of appropriate size assists in locating heat sink pad 300, and transducer assembly 290 shown in FIG. 4 as including piezoelectric element 100 bonded to resonator plate 200. Electrical contact to piezoelectric element 100 can be conveniently made by springs 410 and 418. Spring 410 is fitted within central insulating bushing 408. Conductive lead wire 412 is secured by screw 414 within recessed slot 416 and is in electrical contact with spring 418. Also, threaded holes 420 are disposed around the outer periphery of end face 404, and are configured to receive bolts such as bolts 602 shown in FIG. 11.

FIG. 7 is a top perspective view illustrating heat sink pad 300 inserted into heat sink 400 of FIG. 6, according to a representative embodiment. In particular, heat sink pad 300 is inserted into recessed portion 406 to be in thermal contact with the bottom surface (or floor) and the sidewall of recessed portion 406. As shown, central insulating bushing 408 is pressed into a central hole formed in heat sink 400, and spring 410 is located within bushing 408 to extend above the bottom floor of recessed portion 406 so as to make contact with the contact metallization of piezoelectric element 100 when transducer assembly 290 is inserted into heat sink 400.

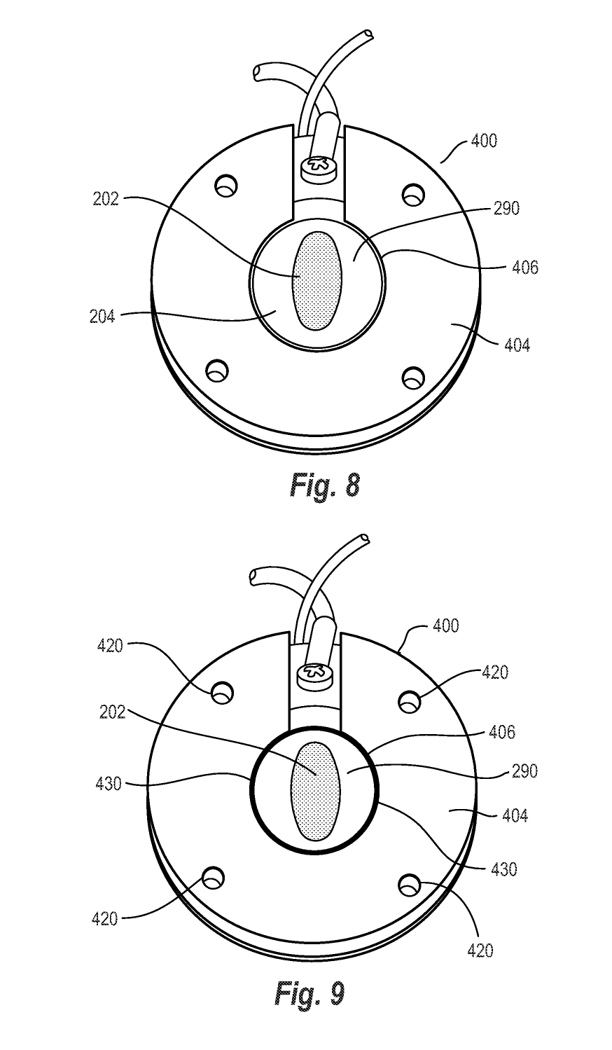

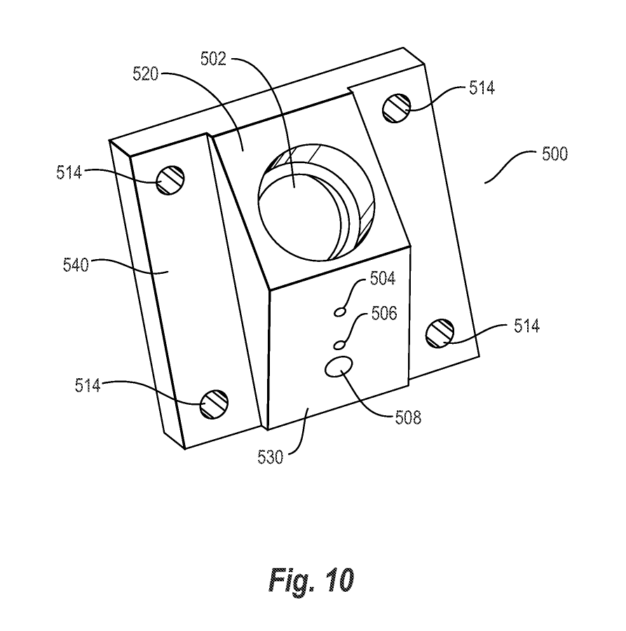

FIG. 8 is a top perspective view illustrating transducer assembly 290 inserted into heat sink 400 of FIG. 7, according to a representative embodiment. In particular, transducer assembly 290 is inserted into recessed portion 406 with second face 120 of piezoelectric element 100 as shown in FIG. 4 facing downward and abutted against heat sink pad 300 (see FIG. 7), in thermal contact with heat sink pad 300. Outer surface 210 of resonator plate 200 including first and second portions 202 and 204 as shown in FIG. 3 faces upward and is exposed at end face 404 of heat sink 400. As should be understood in view of FIGS. 10 and 11 as will be described subsequently, tube 250 as shown in FIG. 4 extends through inlet port 504 of spray chamber body 500 of assembled nebulizer head 600 and is not an integral component or part of transducer assembly 290. Tube 250 is shown in FIG. 4 for purpose of explanation. Accordingly, tube 250 is not shown in FIG. 8.

FIG. 9 is a top perspective view illustrating O-ring 430 inserted into heat sink 400 of FIG. 8, according to a representative embodiment. O-ring 430 may be inserted securely between transducer assembly 290 and the inner side wall of recessed portion 406. O-ring 430 mechanically presses transducer assembly 290 against heat sink pad 300. O-ring 430 prevents liquid from encroaching into recessed portion 406 underneath transducer assembly 290. O-ring 430 further provides a seal between outer surface 210 of transducer assembly 290 and spray chamber body 500 shown in FIGS. 10 and 11, and also prevents liquid from spreading to the peripheral portion of end face 404 of heat sink 400. O-ring 430 may be made of an elastic material such as polytetrafluoroethylene (PTFE) that is chemically inert to the intended sample types. Other plastics, and even rubbers such as Viton®) could be suitable depending on the sample type.

FIG. 10 is a front perspective view illustrating spray chamber body 500, according to a representative embodiment. Spray chamber body 500 as shown in FIG. 10 may be made of plastic or any dimensionally stable material inert to the samples being nebulized, and includes opening 502 at first face 520 through which nebulized mist exits. Spray chamber body 500 may further include inlet port 504 through which inlet sample tube 250 may be passed, inlet port 506 through which tube 606 for supply of gas may be passed and port 508 through which tube 608 used to drain excess liquid from outer surface (nebulizing layer) 210 shown in FIG. 4 may be passed, all disposed in second face 530 of spray chamber body 500. Tubes 250, 604 and 606 are shown in FIG. 11. Ports 504, 506 and 508 extend through spray chamber body 500 from second face 530 to the spray chamber (not shown) behind opening 502. Also provided are non-threaded guide holes 514 for receiving bolts such as bolts 602 shown in FIG. 11 and which extend entirely through spray chamber body 500 from third face 540 to the back face (not shown).

FIG. 11 is a left side perspective view illustrating assembled nebulizer head 600 including heat sink 400 shown in FIG. 9 and spray chamber body 500 shown in FIG. 10, according to a representative embodiment. Spray chamber body 5001 is mounted to heat sink 400 with the back face (not shown) of spray chamber body 500 abutted against end face 404 of heat sink 400. Bolts 602 may be inserted through guide holes 514 of spray chamber body 500 and screwed into threaded holes 420 of heat sink 400 to secure spray chamber body 500 to heat sink 400.

Tubes 250, 606 and 608 shown in FIG. 11 may be inserted through respective ports 504, 506 and 508 in second face 530 shown in FIG. 10. As previously described, tube 250 may or may not be in direct contact with outer surface 210 of transducer assembly 290. Tube 606 which injects nebulizer gas stops short of outer surface 210, terminating inside the spray chamber. The end of tube 608 which drains away excess liquid from the bottom edge of outer surface 210, may make direct contact with or terminate in close proximity to outer surface 210. The inside of tube 608 may be roughened to minimize surface tension effects with the liquid and enhance removal of excess liquid from outer surface 210 of resonator plate 200.

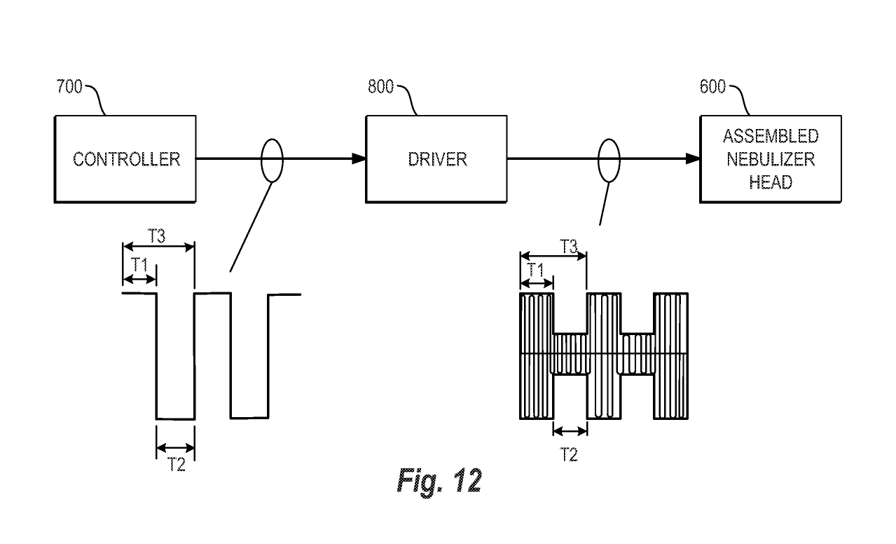

FIG. 12 is a schematic block diagram illustrating controller 700, and driver 800 which provides a drive signal to assembled nebulizer head 600, according to a representative embodiment. Controller 700 generates a control signal which is provided to driver 800. The control signal specifies an amplitude of the drive signal to be output from driver 800 and applied to assembled nebulizer head 200, to control the amount of mist produced. Controller 700 may be a microprocessor, a CPU or discrete electronics and may be physically realized as part of driver 800 or as a separate entity or component. Driver 800 may be an electronic power oscillator configured to drive piezoelectric element 100 at its resonant frequency at the amplitude specified by controller 700.

In representative embodiments, the amount of mist produced by piezoelectric element 100 of assembled nebulizer head 600 is controlled in a repeatable and defined manner by cyclically switching the amplitude of the drive signal provided to piezoelectric element 100 of assembled nebulizer head 600 between two states. Controller 700 may be configured so that during a first state T1 the amplitude of the control signal output from controller 700 shown in FIG. 8 is greater than an amplitude required to cause nebulization at outer surface 210 of resonator plate 200, and so that during a second state T2 the amplitude of the control signal is less than that required to produce mist at outer surface 210 of resonator plate 200. In a representative embodiment, the control signal during second state T2 may have zero amplitude so that piezoelectric element 100 does not vibrate. In another representative embodiment, the control signal during second state T2 may have non-zero amplitude so that piezoelectric element 100 vibrates at a sub-nebulization level so that outer surface 210 of resonator plate 200 does not produce mist. By providing the control signal as having a non-zero amplitude during second state T2, faster transitions may be realized between the first and second states.

Control of the amount of mist output or generated by assembled nebulizer head 600 may be achieved by varying the relative times spent in first state T1 and second state T2, thus controlling the fraction of total time that nebulization occurs. With reference to FIG. 8, this may be achieved by varying the duration of first state T1 alone, by varying the duration of state T2 alone, or by varying the duration of both the first state and the second state. The fraction of time that nebulization occurs may be given as T1/(T1+T2). In a representative embodiment, both the durations of states T1 and T2 may be varied while maintaining period T3 constant. In this manner, driver 800 may provide an oscillating drive signal to assembled nebulizer head 600 as shown in FIG. 12 to control the amount of mist produced, whereby the amplitude and the duration of the first and second states of the drive signal are set according to the control signal provided by controller 700.

Regardless of the control mode used to control the amount of mist produced, the duration of period T3 should be short enough so that the pulsations of nebulization are damped out by the spray chamber (not shown), yet long enough so that the time taken for mist production to stabilize is a small part of the total nebulization time. In a representative embodiment, the duration of period T3 may be in the range 500 ms to 5 ms, corresponding to a repetition frequency in a range of about 2 Hz to 200 Hz. In a further representative embodiment, the repetition frequency may be in a range of about 5 Hz to 50 Hz. In another representative embodiment, driver 800 may be configured to operate in a burst mode so that for each measurement the drive signal is repeatedly switched between the first and second states for a defined period of time, and thereafter is maintained in the second state until a new measurement is desired.

The amount of mist production may thus be controlled in a repeatable and well-defined manner using a drive signal that is cyclically switched between first and second states as described.

As the ultrasonic nebulizers of the described representative embodiments are cyclically switched between a first state that produces mist and a second state that does not produce mist, liquid may build up on outer surface 210 (nebulizing surface) of resonator plate 200 during the times when piezoelectric element 100 is in the second state. Droplets of liquid may build up on outer surface 210 (nebulizing surface) of resonator plate 200 during the second state, and when large enough the droplets may flow away while piezoelectric element 100 remains in the second state, so that when piezoelectric element 100 is switched back to the first state, adequate liquid may not be present on outer surface 210 (nebulizing surface). To better enable stable and efficient nebulizing as piezoelectric element 100 is cyclically switched between the first and second states, in representative embodiments the stability of the thickness of the liquid film on outer surface 210 (nebulizing surface) of resonator plate 200 may be controlled.

In particular, as should be understood, most of the vibration of piezoelectric element 100 occurs at central region 102 shown in FIG. 1. The outer edge of piezoelectric element 100 in annular region 104 typically exhibits less motion. By depositing the liquid onto first (roughened) portion 202 of outer surface 210 of resonator plate 200 shown in FIG. 3 at a point over annular region 104 near the top edge of piezoelectric element 100 as oriented substantially vertically, the liquid may be guided vertically down outer surface 210 under gravity and substantially confined to first region 202 to be over central region 102 of piezoelectric plate 100 where nebulization occurs. As the liquid flows along first region 202 to be over central region 102 of piezoelectric element 100, the liquid flow has time to stabilize and form a liquid film of appropriate thickness. It may thus be possible to prevent formation of liquid droplets and provide a stable thickness of liquid film on outer surface 210 (nebulizing surface) of resonator plate 200, to avoid unstable mist production. The impact of variations in liquid flow and the impact of varying nebulization rates may thus be reduced.

While representative embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the representative embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific representative embodiments described herein. It is, therefore, to be understood that the foregoing embodiments are presented by way of example only and that, within the scope of the appended claims and equivalents thereto, representative embodiments may be practiced otherwise than as specifically described and claimed. Representative embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The phrase “and/or,” as used herein in the specification and in the claims, should be understood to mean “either or both” of the elements so conjoined. In the claims, as well as in the specification above, all transitional phrases such as “comprising,” “including,” “carrying,” “having.” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. An ultrasonic nebulizer comprising:
a piezoelectric element having opposite first and second faces and configured to vibrate in response to a drive signal having an alternating voltage;
a nebulizing layer bonded to the first surface of the piezoelectric element and having an outer surface, the nebulizing layer configured to transform a liquid at the outer surface into a mist responsive to vibration of the piezoelectric element;
a thermally conductive pad thermally connected to the second face of the piezoelectric element, the thermally conductive pad having an opening that exposes a central region of the piezoelectric element; and
a heat sink thermally connected to the thermally conductive pad.

2. The ultrasonic nebulizer of claim 1, wherein the thermally conductive pad comprises a ceramic loaded fiber reinforced silicone material.

3. The ultrasonic nebulizer of claim 1, further comprising:
a driver configured to generate the drive signal that is cyclically switched between at least a first state having an amplitude sufficient to drive the piezoelectric element to produce the mist and a second state having an amplitude insufficient to drive the piezoelectric element to produce the mist, to control the amount of mist produced.

4. The ultrasonic nebulizer of claim 3, wherein a duration of time that the drive signal is in the first state is adjustable to control the amount of mist produced.

5. The ultrasonic nebulizer of claim 3, wherein a period of the drive signal is fixed, and durations of the first and second states are variable to control the amount of mist produced.

6. The ultrasonic nebulizer of claim 3, wherein the amplitude of the drive signal in the second state is non-zero.

7. The ultrasonic nebulizer of claim 3, wherein the drive signal cycles at a frequency within a range of about 2 Hz to 200 Hz.

8. The ultrasonic nebulizer of claim 1, wherein the outer surface of the nebulizing layer is roughened to guide flow of liquid over the nebulizing layer.

9. An ultrasonic nebulizer comprising:
a piezoelectric element having opposite first and second faces and configured to vibrate responsive to a drive signal having a drive frequency; and
a passive resonator bonded to the first face of the piezoelectric element and having an outer surface, the passive resonator configured to transform a liquid at the outer surface into a mist responsive to vibration of the piezoelectric element and to disperse heat from a central region of the piezoelectric element,
the passive resonator comprising a thermally conductive material having a thickness corresponding to an integral number of half wavelengths of the drive frequency, and the outer surface of the passive resonator is roughened to guide flow of the liquid.

10. The ultrasonic nebulizer of claim 9, wherein the passive resonator has a thickness of one half wavelength of the drive frequency.

11. The ultrasonic nebulizer of claim 9, wherein the thermally conductive material has a thermal conductivity of at least 10 watts/meter Kelvin.

12. The ultrasonic nebulizer of claim 9, wherein the thermally conductive material comprises any one of titanium, tantalum, aluminum oxide and aluminum nitride, and is inert to the liquid.

13. The ultrasonic nebulizer of claim 9, wherein a first portion of the outer surface of the passive resonator is roughened, and a second portion of the outer surface is smooth to confine flow of the liquid within the first portion of the outer surface.

14. The ultrasonic nebulizer of claim 9, further comprising:
a thermally conductive pad thermally connected to the second face of the piezoelectric element, the thermally conductive pad having an opening that exposes a central region of the piezoelectric element; and
a heat sink thermally connected to the thermally conductive pad.

15. An ultrasonic nebulizer comprising:
a piezoelectric element having opposite first and second faces and configured to vibrate responsive to a drive signal; and
a nebulizing layer bonded to the first face and having an outer surface, the nebulizing layer configured to transform a liquid at the outer surface into a mist responsive to vibration of the piezoelectric element,
the outer surface of the nebulizing layer being roughened to confine flow of the liquid over the nebulizing layer.

16. The ultrasonic nebulizer of claim 15, wherein the piezoelectric element is oriented substantially vertically, and the first portion of the nebulizing layer begins over a point near a top edge of the piezoelectric element and has a width that increases gradually to a maximum width over a central region of the piezoelectric element.

17. The ultrasonic nebulizer of claim 16, wherein the width of the first portion of the nebulizing layer gradually decreases from the maximum width over the central region of the piezoelectric element to end over a point near a bottom edge of the piezoelectric element.

18. The ultrasonic nebulizer of claim 16, further comprising a structure having a channel configured to remove liquid from a lower edge of the nebulizing layer, wherein the channel is roughened to minimize surface tension effects with the liquid and enhance removal of liquid away from the nebulizing layer.

19. The ultrasonic nebulizer of claim 15, wherein a first portion of the outer surface is roughened, and a second portion of the outer surface is smooth to confine flow of the liquid within the first portion of the outer surface.

20. The ultrasonic nebulizer of claim 15, wherein the first portion of the nebulizing layer is substantially stripe-shaped.
